(19) United States
(12) Patent Application Publication
(10) Pub. No.: US 2005/0174790 A1
(43) Pub. Date: Aug. 11, 2005

(54) Interior illumination lamp

(75) Inventors: Hiroyuki Suzuki, Haibara-gun (JP); Kimihiro Ishii, Haibara-gun (JP); Motoya Kimura, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/969,214

(22) Filed: Oct. 21, 2004

(30) Foreign Application Priority Data
Oct. 22, 2003 (JP) P2003-361793

(51) Int. Cl. B60Q 1/00

(52) U.S. Cl. 362/488; 362/227; 362/490; 362/545

(57) ABSTRACT

When a bezel portion 52 is angularly moved in order to adjust an illuminating direction, a lens 54 and a reflecting plate 40 are angularly moved, but a bulb 37 is not angularly moved since it is fixed to a body 30, and therefore a wire harness W/H, connected to the bulb 37, will not be twisted. Therefore, the cutting of conductors of the wire harness W/H due to the twisting of the wire harness W/H upon adjusting of the illuminating direction as encountered in a conventional construction is prevented. And besides, the lens 54 and the reflecting plate 40 are angularly moved in synchronism with each other, and therefore reflected light from the reflecting plate 40 is always irradiated on a predetermined portion of the lens 54. Therefore, a beam, emitted from the bulb 37, can be efficiently irradiated on an object to be irradiated. A notch 41 is formed in the reflecting plate 40, and therefore the bulb 37 and the reflecting plate 40 can be easily mounted.

### BACKGROUND OF THE INVENTION

1. Field of the invention

This invention relates to an interior illumination lamp mounted, for example, on a door, a ceiling or others of an automobile.

2. Related art

There has been disclosed one example of conventional interior illumination lamps as shown in FIG. 6(see, for example, Japanese Unexamined Patent Publication 2000-1141).

This interior illumination lamp is mounted, for example, on a back door of a station wagon, and is used in this condition, and by changing a direction of illumination, the lamp can illuminate a luggage room (provided at a rear portion of the station wagon) and a zone beneath the opened back door.

As shown in FIG. 6, this interior illumination lamp 100 includes a lamp housing 102 mounted on a trim 101 forming a wall surface of the back door, and a round opening 103 is formed in a front side of this lamp housing 102. A lamp support portion 104, having a generally-spherical inner surface, is provided rearwardly of (at the right side in FIG. 6) the opening 103, and a lamp body 105 of a partially spherical shape is provided inside the lamp support portion 104 so as to rotate through an angle of 360 degrees in a predetermined range. A bulb 106 is mounted within the lamp body 105, and a lens portion 107 is provided at a front side (the left side in FIG. 6) of the lamp body, and projects from the opening 103 in the lamp housing 102. A space S is formed between the lens portion 107 and an edge of the opening 103, and the amount of rotation of the lamp body 105 is limited.

In the above interior illumination lamp 100, the bulb 106, a reflecting plate 108 and the lens portion 107 are, in many cases, integrally connected together, and when the lamp body 105 is angularly moved so as to change the direction of illumination along an optical axis, the bulb 106 is also angularly moved. As a result, a wire harness W/H, connected to the bulb 106, is twisted, and therefore disadvantageously, there has been a fear that when the lamp body is repeatedly angularly moved, conductors of the wire harness W/H are cut.

### SUMMARY OF THE INVENTION

This invention has been made in view of the above problem, and an object of the invention is to provide an interior illumination lamp in which conductors of a wire harness will not be cut when adjusting a direction of illumination.

The above object has been achieved by an interior illumination lamp provided in that the lamp comprises a body for being fixed to a vehicle body, a light source for emitting a beam, a reflecting plate for reflecting the beam from the light source in a predetermined direction, and a bezel portion which is supported by a support portion mounted on the body, and includes a lens capable of transmitting the beam from the light source therethrough, wherein a direction of an optical axis can be adjusted by angularly moving the bezel portion relative to the body; and the light source is fixed to the body.

In the interior illumination lamp of this construction, when the bezel portion is angularly moved in order to adjust the illuminating direction, the lens and the reflecting plate are angularly moved, but the light source is not angularly moved since it is fixed to the body, and therefore a wire harness, connected to the light source, will not be twisted. Therefore, there can be solved a problem that conductors of the wire harness are twisted upon adjusting of the illuminating direction, and are cut as in the conventional construction.

The invention is also provided in that the lens and the reflecting plate can be angularly moved in synchronism with each other.

In the interior illumination lamp of this construction, the reflecting plate and the lens are angularly moved in synchronism with each other, and therefore reflected light from the reflecting plate is always irradiated on a predetermined portion of the lens. Therefore, a beam, emitted from the light source, can be efficiently irradiated on an object to be irradiated.

The invention is further provided in that a notch for preventing the interference of the reflecting plate with the light source is formed in the reflecting plate.

In the interior illumination lamp of this construction, the light source is passed through the notch, thereby preventing the light source from interfering with the reflecting plate, and therefore the light source and the reflecting plate can be easily mounted.

In the present invention, when the bezel portion is angularly moved in order to adjust the illuminating direction, the lens and the reflecting plate are angularly moved, but the light source is fixed to the body, and therefore the wire harness, connected to the light source, will not be twisted. Therefore, there can be solved the problem that the conductors of the wire harness are twisted upon adjusting of the illuminating direction, and are cut as in the conventional construction.

### BRIEF DESCRIPTION OF THE DRAWINGS

FIG. 1 is an exploded, perspective view showing a preferred embodiment of an interior illumination lamp of the invention;

FIG. 2 is a rear view of the interior illumination lamp as seen in a direction II of FIG. 1;

FIG. 3 is a cross-sectional view showing a condition in which the interior illumination lamp of the invention is mounted on a vehicle body;

FIG. 4 is an enlarged view showing the relation between a bulb and a reflecting plate;

FIG. 5 is a cross-sectional view taken along the line V-V of FIG. 4; and

FIG. 6 is a cross-sectional view showing one conventional interior illumination lamp.

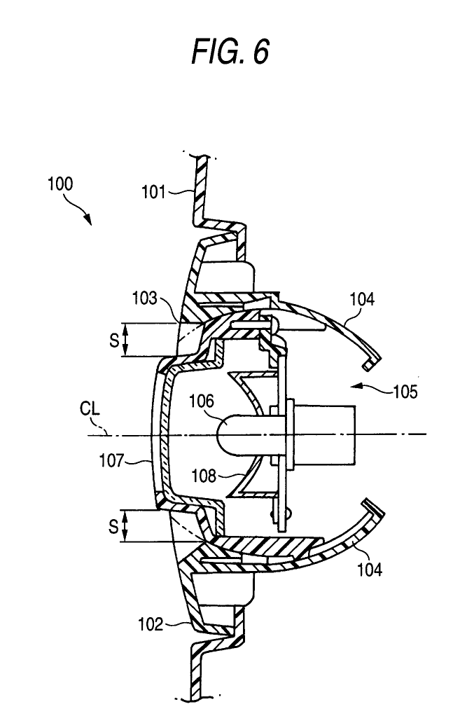

### DETAILED DESCRIPTION OF THE PREFERRED EMBODIMENTS

A preferred embodiment of the present invention will now be described in detail with reference to the drawings.

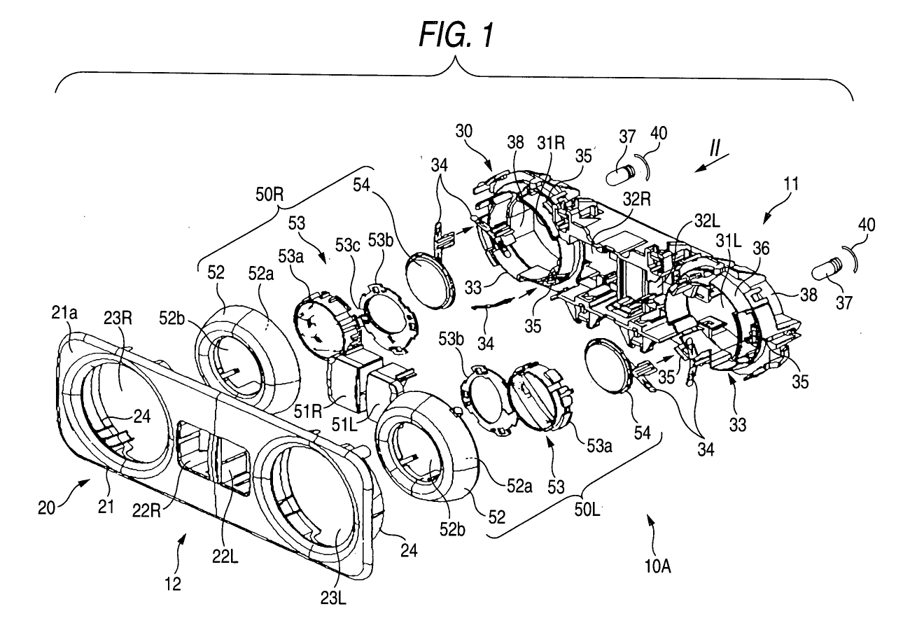

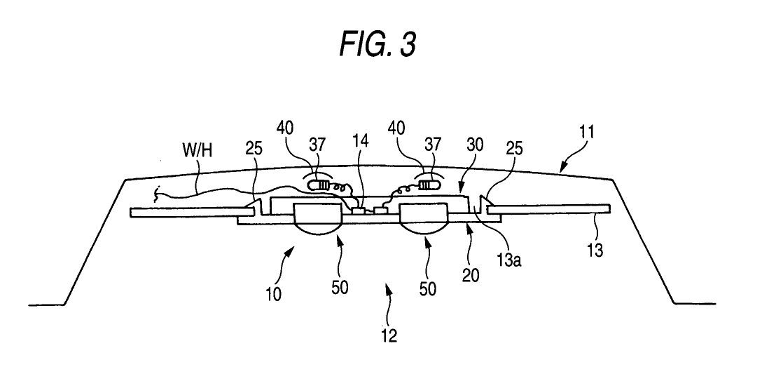

As shown in FIG. 1, the interior illumination lamp 10 of this embodiment includes a design portion 20 for exposure to a car room (passenger compartment) 12 (see FIG. 3), and a function portion body 30 (serving as a body) which is provided on an inner side of the design portion 20, and has various electrical parts mounted thereon.

As shown in FIG. 3, this interior illumination lamp 10 is mounted on the vehicle body 11 by mounting the design portion. 20 on an interior member (trim) 13 beforehand mounted on the inside of the vehicle body 11. The interior illumination lamp 10 can be easily connected to a wire harness W/H beforehand installed on a reverse side of the interior member 13.

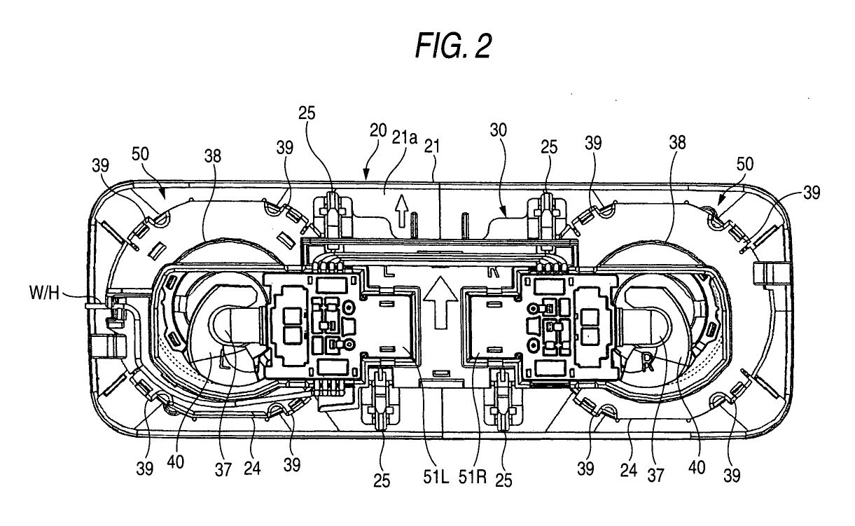

As shown in FIGS. 1 and 2, the design portion 20 includes a housing 21, for example, of a rectangular shape exposed at its surface 21a to the car room 12. Switch holes 22L and 22R are formed through a central portion of the housing 21, and left and right switches 51L and 51R are exposed to the car room 12 respectively through these switch holes 22L and 22R. Also, lamp holes 23L and 23R are formed respectively through left and right portions of the housing 21, and left and right lamps 50L and 50R are exposed to the car room 12 respectively through these lamp holes 23L and 23R. A mounting portion 24 of a generally cylindrical shape is provided at each of the lamp hole portions 23L and 23R, and extends inwardly from a reverse surface 21b of the housing 21, and the function portion body 30 is mounted on the housing 21 through these mounting portions 24. Clips 25 (see FIG. 3) for mounting the housing 21 on the interior member 13 at a ceiling portion of the car room 12 are provided on the reverse surface 21b of the housing 21.

As shown in FIGS. 1 and 2, the function portion body 30 is a frame-like member having an elongated ellipse-shape as a whole, and lamp receiving holes 31L and 31R for respectively receiving the lamps 50L and 50R are formed through left and right end portions thereof, respectively. Switch receiving portions 32L and 32R, in which the switches 51L and 51R are mounted, respectively, are provided at a central portion of the function portion body 30 disposed between the two lamp receiving holes 31L and 31R. Connectors 14, mounted at a distal end portion of the wire harness W/H, are connected to connection terminals of the switches 51L and 51R, and with this construction the switches 51L and 51R can be easily mounted and removed (see FIG. 3).

Ring members 33 of a circular shape, serving as support portions for respectively supporting the lamps 50L ad 50R, are mounted on edges of the two lamp receiving holes 31L and 31R, respectively. A guide member 38 of a generally cylindrical shape is provided at each of the ring members 33, and projects from the reverse side (the right side in FIG. 1) of the function portion body 30. Those portions of the left and right guide members 38, opposed to each other, are notched so that the various electrical parts, including the switches 51L and 51R and bulbs 37 (serving as light sources), can be fixedly mounted on the function portion body 30. The guide members 38 are larger in height than all-of the electrical parts and others mounted on the function portion body, and function to prevent the electrical parts and others from striking against the vehicle body 11. The bulbs 37 can be fixedly mounted within the left and right guide members 38, respectively.

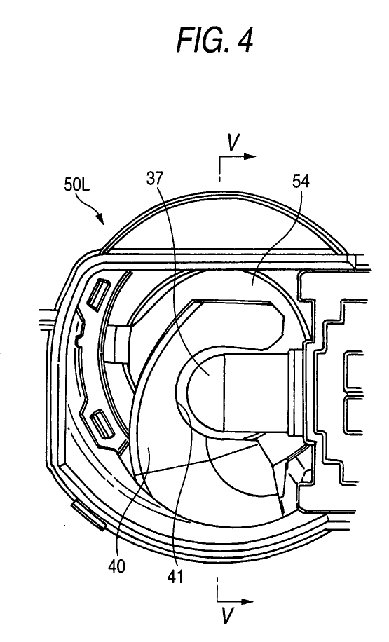

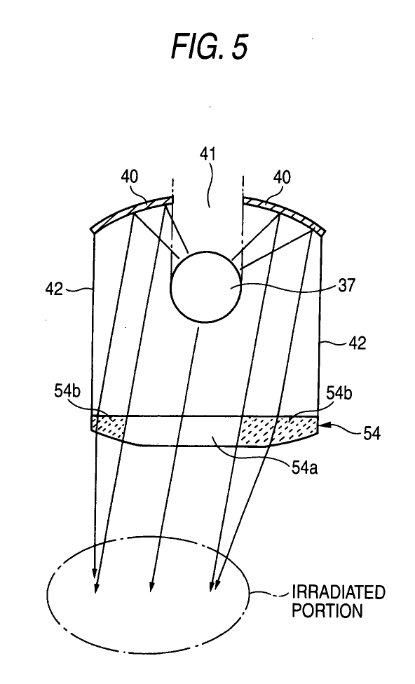

The reflecting plate 40 is provided at the rear side (the right side in FIG. 1) of each of the bulbs 37. As shown in FIGS. 4 and 5, a notch 41, having a width slightly larger than an outer diameter of the bulb 37, is formed through a central portion of the reflecting plate 40 so that the bulb 37 can be passed through the notch 41. Therefore, when mounting the bulb 37 at the front side of the reflecting plate 40, the bulb 37 is passed through the notch 41, and is brought into a position disposed forwardly of the reflecting plate 40, and is mounted and fixed in this proper position. As a result, light, emitted from the bulb 37, can be efficiently radiated in a desired direction.

The notch 41 can be so formed in the reflecting plate 40 that the reflecting plate 40 is symmetrical, and by doing so, the reflecting plates 40 of an identical construction can be used in common for the left and right bulbs 37, respectively, and as a result the erroneous mounting of the reflecting plate can be prevented.

As shown in FIG. 1, sliding contact member-mounting recesses 35 (each for the mounting of a metallic sliding contact member 34 therein) are formed respectively, for example, in three portions of an inner peripheral surface of each ring member 33 equally spaced circumferentially from one another. The sliding contact members 34 are inserted respectively into the sliding contact member-mounting recesses 35 to be mounted therein.

The sliding contact member 34 is a metallic member of a generally T-shape having resiliency, and is normally pressed against a spherical surface 52a by its own resilient force. The sliding contact member 34 may be made of a resin, and also may have other shape than the generally T-shape.

As shown in FIG. 1, guide portions 36 are formed on the outer surface of each of the ring members 33 (provided respectively at the lamp receiving holes 31L and 31R), and project a step therefrom. When the sliding contact members 34 are fittingly mounted respectively in the sliding contact member-mounting recesses 35, an outer surface of each of the guide portions 36 lies between the corresponding adjacent siding contact members 34 in concentric relation thereto, and these guide portions 36 are disposed inwardly of a concentric circle (the spherical surface 52a) on which a sliding contact surface for the sliding contact members 34 are disposed.

A plurality of retaining claws 39 for mounting the function portion body 30 are formed on the outer surface of each ring member 33 at suitable intervals. Therefore, each mounting portion 24 of the design portion 20 is held between the retaining claws 39 and the ring member 33, thereby connecting the function portion body 30 and the housing 21 of the design portion 20 together.

As shown in FIG. 1, the left and right lamps 50L and 50R are mounted between the design portion 20 and the function portion body 30. The left and right lamps 50L and 5OR have the same construction, and therefore in the following description, these will be referred to merely as the lamp 50 unless otherwise specified.

The lamp 50 includes an outer bezel 52, an inner bezel 53, and a lens 54, and this lamp 50 radiates rays of light, emitted from the bulb 37, in a predetermined direction.

The outer bezel 52 has such a size that its distal end portion projects into the car room 12 through the lamp hole 23L, 23R in the design portion 20. The outer bezel 52 has a partially spherical shape as a whole, and the concave spherical surface 52a is formed on an inner surface thereof. A window 52b in which the lens 54 fits is formed through a central portion of the outer bezel.

The inner bezel 53 includes a bezel body 53a of a generally cylindrical shape, and a lens holder 53b mounted on the bezel body 53a through a hinge 53c so as to be opened and closed. Therefore, a convex surface of the lens 54 is fitted in a rear end portion of the bezel body 53a, and the lens holder 53b is closed, thereby holding the lens 54.

The inner bezel 53 is engaged in the inside of the outer bezel 52, so that the lens 54 is retained in a double manner.

The left and right lamps 50L and 5OR are mounted respectively in the lamp receiving holes 31L and 31R in the function portion body 30 in such a manner that each lamp 50L, 5OR can be angularly moved (turned), and can also be fixed in a predetermined position. Namely, as shown in FIG. 1, the three sliding contact members 34, mounted on the function portion body 30, are disposed inside the outer bezel 52, and are resiliently pressed against the spherical surface 52a of the outer bezel 52, so that the outer bezel 52 can be angularly moved relative to the function portion body 30, and can also be fixed in a desired position.

As shown in FIG. 5, the reflecting plate 40 and the lens 54 can be angularly moved in synchronism with each other. Namely, the reflecting plate 40 and the lens 54 can be integrally interconnected by an interconnecting member 42. In this case, also, the notch 41, so sized as to allow the bulb 37 to pass therethrough, is formed in the reflecting plate 40, and therefore there is no problem with the mounting operation. There can be used another alternative method in which the reflecting plate 40 and the lens 54 are not directly connected together, and there are provided separate angularly-moving means for respectively angularly moving the reflecting plate 40 and the lens 54 in synchronism with each other.

The lens 54 includes a passing portion 54a for passing incident light therethrough as it is, and a refracting portion 54b for refracting incident light toward the center, and this lens 54 causes a beam from the bulb 37 to be efficiently irradiated on an object to be irradiated. A beam, incident on the refracting portion 54b, is refracted toward the center, and by doing so, a peripheral portion of the lens 54 is prevented from shining, thereby reducing the degree of irradiation of the glaring light on the driver and the passenger.

In the above interior illumination lamp 10, when the outer bezel 52 is angularly moved in order to adjust the illuminating direction, the lens 54 and the reflecting plate 40 are angularly moved, but the bulb 37 is not angularly moved since it is fixed to the function portion body 30, and therefore the wire harness W/H, connected to the bulb 37, will not be twisted. Therefore, the cutting of conductors of the wire harness W/H due to the twisting of the wire harness W/H upon adjusting of the illuminating direction is prevented.

And besides, the reflecting plate 40 and the lens 54 are angularly moved in synchronism with each other, and therefore reflected light from the reflecting plate 40 is always irradiated on a predetermined portion of the lens 54. Therefore, a beam, emitted from the bulb 37, can be efficiently irradiated on the object to be irradiated. The notch 41 for preventing the interference of the reflecting plate 40 with the bulb 37 is formed in the reflecting plate 40, and therefore the bulb 37 or the reflecting plate 40 can be easily mounted.

The interior illumination lamp 10 of the invention is not limited to the above embodiment, and suitable modifications, improvements, etc., can be made.

For example, in the above embodiment, although there are provided the pair of left and right lamps 50L and 50R, the number of the lamps 50 is arbitrary. Therefore, the number of the lamp holes 23 as well as the number of the switch holes 22 corresponds to the number of the lamps 50, and can vary suitably.

And besides, the material, shape, dimensions, form, number, mounting position, etc., of the sliding contact member, outer bezel, inner bezel, function potion body, design portion housing, etc., of the above embodiment are arbitrary, and are not limited in so far as the invention can be achieved.

1. An interior illumination lamp comprising:
a body fixed to a vehicle body;
a light source, for emitting a beam, attached to said body;
a reflecting plate for reflecting the beam from said light source in a predetermined direction; and
a bezel portion supported by a support portion mounted on said body, and including a lens capable of transmitting the beam from said light source therethrough,
wherein a direction of an optical axis of said light source is adjusted by rotating said bezel portion relative to said body.

2. An interior illumination lamp according to claim 1, wherein said lens and said reflecting plate rotate in synchronism with each other.

3. An interior illumination lamp according to claim 1, wherein a notch for preventing the interference of said reflecting plate with said light source is formed in said reflecting plate.

4. An interior illumination lamp according to claim 2, wherein a notch for preventing the interference of said reflecting plate with said light source is formed in said reflecting plate.
